(19) United States
(12) Patent Application Publication
(10) Pub. No.: US 2025/0106104 A1
(43) Pub. Date: Mar. 27, 2025

(54) DATA TRANSFER MANAGEMENT IN A NETWORK

(71) Applicant: Rakuten Symphony, Inc., Tokyo (JP)

(72) Inventors: Kexuan SUN, Weybridge, Surrey (GB); Ravi CHAMARTY, Tewksbury, MA (US)

(73) Assignee: Rakuten Symphony, Inc., Tokyo (JP)

(21) Appl. No.: 18/580,925

(22) PCT Filed: Dec. 4, 2023
(86) PCT No.: PCT/US2023/082264

§ 371 Date: Jan. 19, 2024

Related U.S. Application Data
(60) Provisional application No. 63/448,893, filed on Feb. 28, 2023.

(51) Int. Cl. H04L 41/082; H04L 41/0853; H04W 24/02

(52) U.S. Cl. CPC H04L 41/082; H04L 41/0853; H04W 24/02

(57) ABSTRACT

Provided are apparatus, method, and device for automatically manage data transfer in a network. According to embodiments, the apparatus may be configured to: receive, from an rApp or other SMO functions, at least one of a request to obtain a configuration data of an O-RAN network element, and a request to update configurations of an O-RAN network element; in response to receiving the request to obtain the configuration data of the O-RAN network element, obtain the configuration data using a read storage; and in response to receiving the request to update the configurations of the O-RAN network element, update the configurations of the O-RAN network element based on a configuration provided in the request using a write storage different from the read storage; wherein the write storage and the read storage may be included in the apparatus.

This application claims priority from U.S. Provisional Patent Application No. 63/448,893, filed with the United States Patent and Trademark Office on Feb. 28, 2023 and entitled “A DUAL CACHE AND ASYNCHRONIZED APPROACH FOR SMO/NON-RT RIC CM READ AND WRITE CONFIGURATION DATA OPERATIONS”, the disclosure of which is incorporated herein by reference in its entirety.

### TECHNICAL FIELD

Systems, methods, and computer programs consistent with example embodiments of the present disclosure relate to a telecommunication network, and more specifically, relate to the management of data transfer in a telecommunication network.

### BACKGROUND

A radio access network (RAN) is an important component in a telecommunications system, as it connects end-user devices (or user equipment) to other parts of the network. The RAN includes a combination of various O-RAN network elements (NEs) that connect end-users to a core network. Traditionally, hardware and/or software of a particular RAN is vendor specific.

Open RAN (O-RAN) technology has emerged to enable multiple vendors to provide hardware and/or software to a telecommunications system. Since different vendors are involved, the type of hardware and/or software provided may also be different. That is, different types of NEs may be provided by different vendors, and depending on the specific service, the NE could be virtualized in software form (e.g., virtual machine (VM)-based), or could be in physical hardware form (e.g., non-VM based).

To this end, O-RAN disaggregates the RAN functions into a centralized unit (CU), a distributed unit (DU), and a radio unit (RU). The CU may be a logical node for hosting Radio Resource Control (RRC), Service Data Adaptation Protocol (SDAP), and/or Packet Data Convergence Protocol (PDCP) sublayers of the RAN. The DU may be a logical node hosting Radio Link Control (RLC), Media Access Control (MAC), and Physical (PHY) sublayers of the RAN. The RU may be a physical node that converts radio signals from antennas to digital signals that can be transmitted over the Front Haul to a DU. Because these entities have open protocols and interfaces between them, they can be developed by different vendors.

FIG. 1 illustrates an O-RAN architecture in the related art. RAN functions in the O-RAN architecture may be controlled and optimized by a RAN Intelligent Controller (RIC). The RIC may be a software-defined component that implements modular applications to facilitate the multivendor operability required in the O-RAN system, as well as to automate and optimize RAN operations. As shown in FIG. 1, the RIC may be divided into two types: a non-real-time RIC (Non-RT RIC) 120 and a near-real-time RIC (Near-RT RIC) 130.

The Non-RT RIC 120 may be the control point of a non-real-time control loop and may operate on a timescale greater than 1 second within a Service Management and Orchestration (SMO) framework 110. Its functionalities may be implemented through modular applications called rApps, and may include: providing policy based guidance and enrichment across the Al interface, which is the interface that enables communication between the Non-RT RIC and the Near-RT RIC; performing data analytics; Artificial Intelligence/Machine Learning (AI/ML) training and inference for RAN optimization; and/or recommending configuration management actions over the O1 interface, which may be the interface that connects the SMO to RAN managed elements (e.g., Near-RT RIC 130, O-RAN Centralized Unit (O-CU) 140,150, O-RAN Distributed Unit (O-DU) 170, etc.).

The Near-RT RIC 130 may operate on a timescale between 10 milliseconds and 1 second and may be coupled with the O-DU 170, the O-CU (disaggregated into the O-CU control plane (O-CU-CP) 140 and the O-CU user plane (O-CU-UP) 150), and an open evolved NodeB (O-eNB) 160 via the E2 interface. The Near-RT RIC 130 may use the E2 interface to control the underlying RAN elements (E2 nodes/network functions (NFs)) over a near-real-time control loop. The Near-RT RIC 130 may monitor, suspend/stop, override, and control the E2 nodes (O-CU 140,150, O-DU 170, and O-eNB 160) via policies. For example, the Near-RT RIC 130 may set policy parameters on activated functions of the E2 nodes. Further, the Near-RT RIC 130 may host xApps to implement functions such as quality of service (QoS) optimization, mobility optimization, slicing optimization, interference mitigation, load balancing, security, etc.

Here, the O-CU-CP 140 and the O-CU-UP 150 may be coupled to each other via the E1 interface, and may be coupled to the O-DU 170 via the F1-c interface and F1-u interface, respectively. Further, the O-RU 180 may be coupled to the O-DU 170 via the Open Fronhaul (OF) Control (C), User (U), Synchronization(S), and Management (M) Planes, and may be coupled to the SMO 110 via the OF M-Plane.

The two types of RICs work together to optimize the O-RAN. For example, the Non-RT RIC 120 may provide the policies, data, and AI/ML models enforced and used by the Near-RT RIC 130 for RAN optimization, and the Near-RT RIC 130 may return policy feedback (i.e., how the policy set by the Non-RT RIC 120 works).

As mentioned above, the Non-RT RIC 120 may be located within the SMO framework 110, which manages and orchestrates RAN elements. Specifically, the SMO 110 may manage and orchestrate what is referred to as the O-Ran Cloud (O-Cloud) 190. The O-Cloud 190 may be a collection of physical RAN nodes that host the RICs, O-CUs, and O-DUs, the supporting software components (e.g., the operating systems and runtime environments), and the SMO 110 itself. In other words, the SMO 110 may manage the O-Cloud 190 from within. The O2 interface may be the interface between the SMO 110 and the O-Cloud 190 it resides in. Through the O2 interface, the SMO 110 may provide infrastructure management services (IMS) and deployment management services (DMS).

### SUMMARY

Example embodiments of the present disclosure automatically manage data transfer using at least two storages. As such, example embodiments of the present disclosure allows for data to be transferred within the network while avoiding unnecessary signaling load, bandwidth overhead, and delay, which improves the scalability of the network.

According to embodiments, an apparatus is provided. The apparatus may be configured to: receive, from an rApp or other SMO functions, at least one of a request to obtain a configuration data of an O-RAN network element, and a request to update configurations of an O-RAN network element; in response to receiving the request to obtain the configuration data of the O-RAN network element, obtain the configuration data using a read storage; and in response to receiving the request to update the configurations of the O-RAN network element, update the configurations of the O-RAN network element based on a configuration provided in the request using a write storage different from the read storage; wherein the write storage and the read storage may be included in the apparatus.

According to embodiments, an apparatus is provided. The apparatus may be configured to: receive, from an rApp or other SMO functions, at least one of a request to obtain a configuration data of an O-RAN network element, and a request to update configurations of an O-RAN network element; in response to receiving the request to obtain the configuration data of the O-RAN network element, obtain the configuration data using a first digital twin; and in response to receiving the request to update the configurations of the O-RAN network element, update the configurations of the O-RAN network element based on a configuration provided in the request using a second digital twin different from the first digital twin; wherein the first digital twin and the second digital twin may be included in the apparatus, and wherein the first digital twin and the second digital twin may include a full digital replica of the O-RAN network element.

According to embodiments, a method is provided. The method may include: receiving, from an rApp or other SMO functions, at least one of a request to obtain a configuration data of an O-RAN network element, and a request to update configurations of an O-RAN network element; in response to receiving the request to obtain the configuration data of the O-RAN network element, obtaining the configuration data using a read storage; and in response to receiving the request to update the configurations of the O-RAN network element, updating the configurations of the O-RAN network element based on a configuration provided in the request using a write storage different from the read storage; wherein the write storage and the read storage may be included in an apparatus that performs the method.

According to embodiments, a method is provided. The method may include: receiving, from an rApp or other SMO functions, at least one of a request to obtain a configuration data of an O-RAN network element, and a request to update configurations of an O-RAN network element; in response to receiving the request to obtain the configuration data of the O-RAN network element, obtaining the configuration data using a first digital twin; and in response to receiving the request to update the configurations of the O-RAN network element, updating the configurations of the O-RAN network element based on a configuration provided in the request using a second digital twin different from the first digital twin; wherein the first digital twin and the second digital twin may be included in an apparatus that performs the method, and wherein the first digital twin and the second digital twin may include a full digital replica of the O-RAN network element.

According to embodiments, a non-transitory computer-readable recording medium is provided. The non-transitory computer-readable recording medium may have recorded thereon instructions executable by an apparatus to cause the apparatus to perform a method including: receiving, from an rApp or other SMO functions, at least one of a request to obtain a configuration data of an O-RAN network element, and a request to update configurations of an O-RAN network element; in response to receiving the request to obtain the configuration data of the O-RAN network element, obtaining the configuration data using a read storage; and in response to receiving the request to update the configurations of the O-RAN network element, updating the configurations of the O-RAN network element based on a configuration provided in the request using a write storage different from the read storage; wherein the write storage and the read storage may be included in the apparatus.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates an O-RAN architecture in the related art;

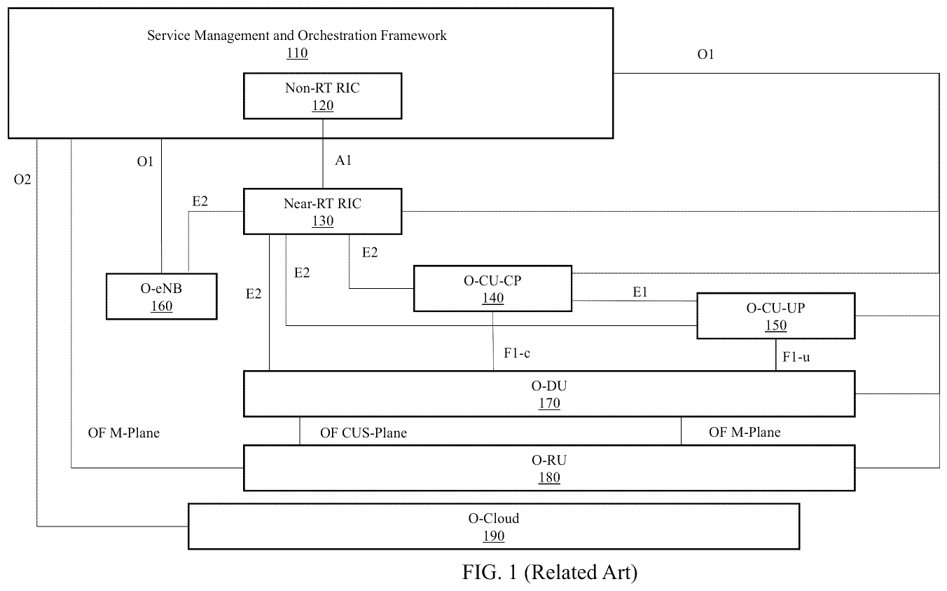

FIG. 2 illustrates a Service Management and Orchestration Framework architecture in the related art;

FIG. 3A illustrates an example flow of data in a system for managing data transfer in a network, according to one or more embodiments;

FIG. 3B illustrates an example flow of data in a system for managing data transfer in a network, according to one or more embodiments

FIG. 4 illustrates a flow diagram of an example method for managing data transfer, according to one or more embodiments;

FIG. 5 illustrates a block diagram of an example interaction between an rApp or other SMO functions and the RAN OAM related Functions, according to one or more embodiments;

FIG. 6A illustrates an example flow of data in a system for managing data transfer in a network, according to one or more embodiments;

FIG. 6B illustrates an example flow of data in a system for managing data transfer in a network, according to one or more embodiments;

FIG. 7 illustrates a flow diagram of an example method for obtaining the configuration data using the read storage, according to one or more embodiments;

FIG. 8A discloses the call flows for an rApp to obtain the configuration data using the read storage in the RAN OAM-related functions, according to one or more embodiments;

FIG. 8B discloses the call flows for other SMO Functions (SMOFs) to obtain the configuration data using the read storage in the RAN OAM-related functions, according to one or more embodiments;

FIG. 9A discloses the call flow for an rApp to obtain the configuration data without using the read storage;

FIG. 9B discloses the call flows for other SMO Functions (SMOFs) to obtain the configuration data without using the read storage;

FIG. 10 illustrates a flow diagram of an example method for updating configurations of an O-RAN network element using a write storage, according to one or more embodiments;

FIG. 11A discloses the call flow for an rApp to update the configurations of the O-RAN network elements using the write storage, according to one or more embodiments;

FIG. 11B discloses the call flows for other SMO Functions (SMOFs) to update the configurations of the O-RAN network elements using the write storage, according to one or more embodiments;

FIG. 12A discloses the call flow for an rApp to update the configurations of the O-RAN network element without using the write storage;

FIG. 12B discloses the call flows for other SMO Functions (SMOFs) to update the configurations of the O-RAN network elements without using the write storage; and

FIG. 13 illustrates a diagram of an example environment in which systems and/or methods, described herein, may be implemented.

### DETAILED DESCRIPTION

The following detailed description of example embodiments refers to the accompanying drawings. The same reference numbers in different drawings may identify the same or similar elements.

The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are disclosed in the specification, these combinations are not intended to limit the disclosure of possible implementations. In fact, many of these features may be combined in ways not specifically disclosed in the specification.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

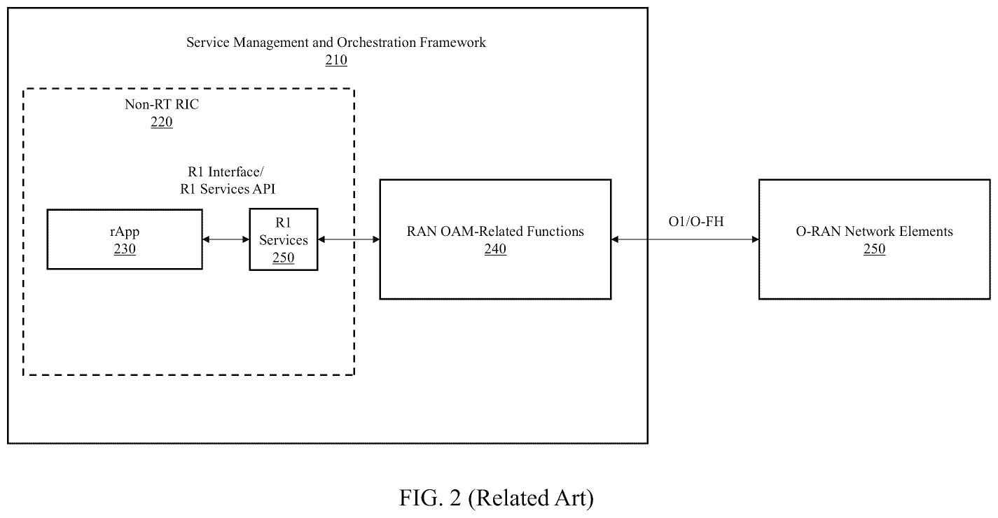

FIG. 2 illustrates a Service Management and Orchestration Framework architecture in the related art. As shown in FIG. 2, a Service Management and Orchestration Framework (SMO) 210 may include a Non-real-time RIC (Non-RT RIC) 220 and RAN Operation and Maintenance (OAM)-related functions 240. Non-RT RIC 220 provide a software framework for applications, rApps, to run.

The rApps 230 may refer to software applications that are configured to run on the Non-RT RIC 220. The RAN OAM-related functions 240 may refer to functions within the SMO 210 that are related to Operation and Maintenance. The one or more O-RAN network elements 250 may refer to O-RAN network elements within the O-RAN architecture. For example, the one or more O-RAN network elements 250 may include O-RAN Centralized Unit Control Plane (O-CU-CP), include O-RAN Centralized Unit User Plane (O-CU-UP), O-RAN Distributed Unit (O-DU), and the like.

The one or more rApps 230 may be configured to perform a read operation (operation to obtain data) and a write operation (operation to update data) of Configuration Management (CM) configuration data for the one or more O-RAN Network Elements 250. For example, the one or more rApps 230 may read/write CM configuration data from/to the one or more O-RAN Network Elements 250 via R1 Services APIs of the R1 Services 250 exposing the Configuration Management (CM) services provided by the RAN OAM-related functions 240 in the SMO 210.

In the related art, in order to perform the read and write operations, the one or more rApps 230 may transmit requests to the RAN OAM-related functions 240 via the R1 interface, where the RAN OAM-related functions 240 may simply directly forward the requests to the one or more O-RAN Network Elements 250 via the O1 or Open Fronthaul (O-FH) interfaces in order to obtain (read) or modify (write) the Managed Object Instance (MOI) attributes from/to the one or more O-RAN Network Elements 250 as requested.

In this regard, the above approach for performing the read and write operations in the related art may have the following shortcomings. Since the RAN OAM-related functions 240 in the SMO 210 simply forwards information to/from the rApps transparently, the one or more rApps 230 essentially directly access the one or more O-RAN Network Elements 250 for each MOI read and write requests in a stateless direct mediation approach. Accordingly, as the system scales up and the number of rApps and O-RAN Network Elements increase, there may be cases where many rApps attempt to read and write CM configuration data at the same time, which could easily overload the R1, O1, and O-FH interfaces resulting in significant message drops and unacceptable signaling delay.

Accordingly, system, methods, devices, and the like, provided in the example embodiments of the present disclosure automatically manage data transfer using at least two storages.

According to embodiments, in order to perform a read operation to obtain a configuration data of an O-RAN network element, the system may obtain the configuration data using a read storage. Further, in order to perform a write operation to update configurations of the O-RAN network element, the system may update the configurations of the O-RAN network element based on a configuration provided in a request using a write storage that is different from the read storage.

Ultimately, example embodiments of the present disclosure automatically manage data transfer using at least two storages, which allows for data to be transferred within the network while avoiding unnecessary signaling load, bandwidth overhead, and delay, which improves the scalability of the network.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the threshold tuning system of the present disclosure, according to one or more embodiments, are provided in the following.

### System Architecture

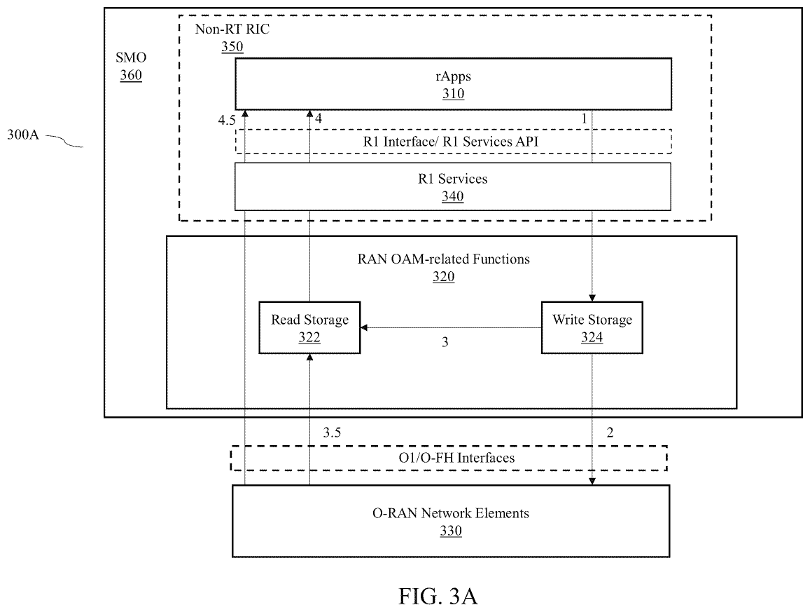

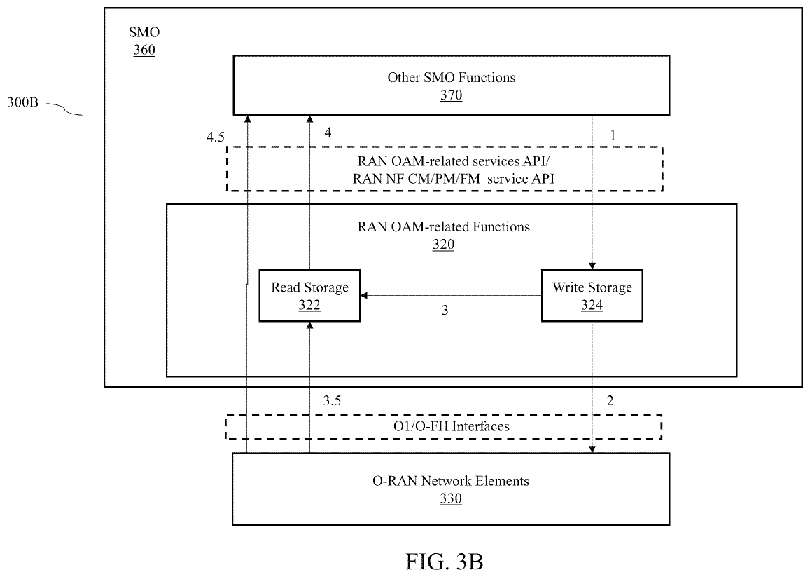

FIG. 3A illustrates an example flow of data in a system 300A for managing data transfer in a network, according to one or more embodiments.

As illustrated in FIG. 3A, system 300A may include a SMO 360, Non-RT RIC 350, R1 services 340, rApps 310, RAN OAM-related Functions 320 including a read storage 322 and a write storage 324, and O-RAN network elements 330.

At step 1, in order to perform a write operation to update the O-RAN network elements 330, an rApp 310 may transmit the configuration data (hereinafter “write data”) which the O-RAN network elements 330 are to be updated based on the R1 Writing configuration changes operation to the RAN OAM-related functions 320, where the write data may be stored in the write storage 324.

At step 2, once the write data is received and stored in the write storage 324, the RAN OAM-related functions 320 retrieve the write data and update the O-RAN network elements 330 based on the write data stored in the write storage 324, such that the write data is populated to the O-RAN network elements 330.

The above process involving the write storage 324 allows the rApp 310 to simply provide the write data to the RAN OAM-related functions 320 via the R1 services API of the R1 Services 340 and to be free to perform other tasks while the write data is being populated to the O-RAN network elements 330 and the O-RAN network elements 330 are being updated based on the write data, without having to wait for the completion of the update. Subsequently, the above process prevents a case where too many rApp or other SMO functions are being held at the same time as they are waiting for their respective update request to be completed, which may lead to platform overloading in signaling spike occasions.

At step 3, once the O-RAN network elements 330 is updated based on the write data, the RAN OAM-related functions 320 may update the read storage 322, such that data stored in the read storage 322 correctly reflects data in the O-RAN network elements 330 after being updated. In this regard, since the write data (which the O-RAN network elements 330 are updated based on) is already stored in the write storage 324 at the RAN OAM-related functions 320, the RAN OAM-related functions 320 may update the read storage 322 based on the write data stored in the write storage 324.

The above process allows for the read storage 322 to be updated such that data stored in the read storage 322 correctly reflects the configurations in the O-RAN network elements 330, without having to directly communicate with the O-RAN network elements and retrieve the configurations from the O-RAN network elements again 330, thereby avoiding unnecessary signaling load, bandwidth overhead, and delay associated with communicating directly with the O-RAN network elements 330. Subsequently, the above process reduces processing and memory load on the SMO and RIC platform, which improves the scalability of the network.

According to embodiments, in addition to step 3, at step 3.5, the RAN OAM-related functions 320 may further update the read storage 322 if there are any configuration updates in the O-RAN network elements by other entities outside the SMO 360, in order to ensure that the data stored in the read storage 322 correctly reflects configurations in the O-RAN network elements 330. According to embodiments, the RAN OAM-related functions 320 may update the read storage 322 by checking the latest configurations in the O-RAN network elements 330 periodically or being notified by the O-RAN network elements when there is a configuration change by other entities outside the SMO.

At step 4, in order to perform a read operation to obtain data from the O-RAN network elements 330, an rApp 310 may, based on R1 Reading configuration data operation, obtain the data (hereinafter “read data”) from the read storage 322 at the RAN OAM-related functions 320.

The above process involving the read storage 322 allows for the rApp 310 to obtain the read data from the RAN OAM-related functions 320, without having to communicate with the O-RAN network elements 330 and directly fetch the data from the O-RAN network elements, thereby avoiding unnecessary signaling load, bandwidth overhead, and delay associated with communicating with the O-RAN network elements 330. Subsequently, the above process reduces processing and memory load on the SMO and RIC platform, which improves the scalability of the network.

According to embodiments, at step 4.5, in the event that the read data, which the rApp 310 would like to obtain, is not stored in the read storage 322, the rApp 310 may obtain the read data from the O-RAN network elements 330 directly.

According to embodiments, in the event that an rApp tries to retrieve the current configuration data from the O-RAN network elements based on the R1 Reading configuration data operation, whether the read data is provided from the read store in the RAN OAM-related functions or freshly fetched from the O-RAN network elements over O1/O-FH interface by the RAN OAM-related function, is determined by the RAN OAM-related functions. The rApp who send the R1 Read configuration data request simply obtains the current configuration data in the O-RAN network elements after sending R1 Reading configuration request, no matter whether that configuration data is retrieved from the read storage in the RAN OAM-related functions or retrieved from the O-RAN network elements by the RAN OAM-related functions via the O1/O-FH interfaces.

In view of the above, it can be understood that the above process involving two separate storages (read storage 322 and write storage 324) allows for the read data to be obtained from the O-RAN network elements 330 and for the write data to be transmitted to the network elements 330, without interfering with each other.

For example, a first rApp may transmit a write data to the write storage 324 during step 1. However, a second rApp may obtain a read data from the read storage 322 during step 4, before the read storage is updated based on the write data during steps 2 and 3.

In this regard, since the read data obtained by the second rApp is the data stored in the read storage 322 rather than the data stored in the write storage 324, the read data obtained by the second rApp will be the data that correctly reflects actual configuration data in the O-RAN network elements 330 (which is currently in effect), rather than the write data that has not yet been applied to the O-RAN network elements 330 yet.

Further, since the write data is transmitted to and stored in the write storage 324 rather than in the read storage 322, the write data will not accidentally overwrite data in the read storage 322 (which correctly reflects data in the O-RAN network elements 330). Accordingly, it may be understood that the rApp 310 may not have access to write (transmit) data to the read storage 322.

It can be understood that the configuration illustrated in FIG. 3A is simplified for descriptive purpose, and is not intended to limit the scope of the present disclosure in any way. Specifically, in practice, the number of rApps 310 and the number of O-RAN network elements 330 can be any number. Further, the numeric labeling of steps 1 to 4 are provided for labeling purpose, and is not intended to limit the order. For example, rApp 310 may perform the read operation and step 4 first, and then perform the write operation and step 1 later. Moreover, the arrows drawn in FIG. 3A represent the flows of configuration data, namely read/write data, across different elements in the figure, rather than representing the actual O-RAN interfaces (virtual/physical) between different the elements in the figure. The actual O-RAN interfaces are represented by the dotted box with the O-RAN interface names enclosed.

Further, while the examples described in the present disclosure are provided in relation to Non-RT RIC, it may be understood that the same can be applied to Near-RT RIC, where the R1 interface becomes the Near-RT RIC API, and the O1/O-FH interfaces become the E2 interface.

FIG. 3B illustrates an example flow of data in a system 300B for managing data transfer in a network, according to one or more embodiments.

As illustrated in FIG. 3B, the configuration of system 300B may be similar to the configuration of system 300A in FIG. 3A, where operations related to the read data and write data are performed by other SMO functions 370 via RAN OAM-related services API/RAN NF CM/PM/FM service API instead of rApps 310 via R1 Interface/R1 Services API and R1 Services 340.

Accordingly, it may be understood that other SMO functions 370 may perform a write operation to update the O-RAN network elements 330 as well as perform a read operation to obtain data from the O-RAN network elements 330, in the similar manner as the rApps 310.

### Example Operations for Managing Data Transfer in the Present Disclosure

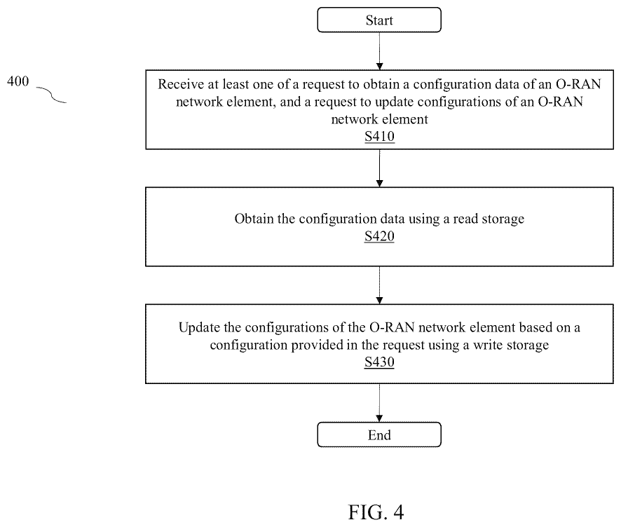

In the following, several example operations of the present disclosure are described with reference to FIG. 4 to FIG. 12.

FIG. 4 illustrates a flow diagram of an example method 400 for managing data transfer, according to one or more embodiments. One or more operations in method 400 may be performed by at least one processor.

As illustrated in FIG. 4, at operation S410, the at least one processor may be configured to receive at least one of a request to obtain a configuration data of an O-RAN network element, and a request to update configurations of an O-RAN network element. It may be understood that the request to obtain the configuration data of the O-RAN network element may refer to a request to perform a read operation. Similarly, it may be understood that the request to update the configurations of the O-RAN network element may refer to a request to perform a write operation. According to embodiments, the request to obtain the configuration data and the request to update the configurations of the O-RAN network element may be received from an rApp or other SMO functions.

According to embodiments, the configuration data may include configuration data of the O-RAN network element which the rApp or other SMO functions would like to obtain for the read operation. For example, the configuration data may include CM configuration data of the O-RAN network element which an rApp would like to read. According to embodiments, the request to update the configurations of the O-RAN network element may include a configuration which the rApp or other SMO functions would like the O-RAN network element to be updated based on for the write operation. For example, the request may include CM configuration data, which the rApp would like to write to the O-RAN network element. The method then proceeds to operation S420.

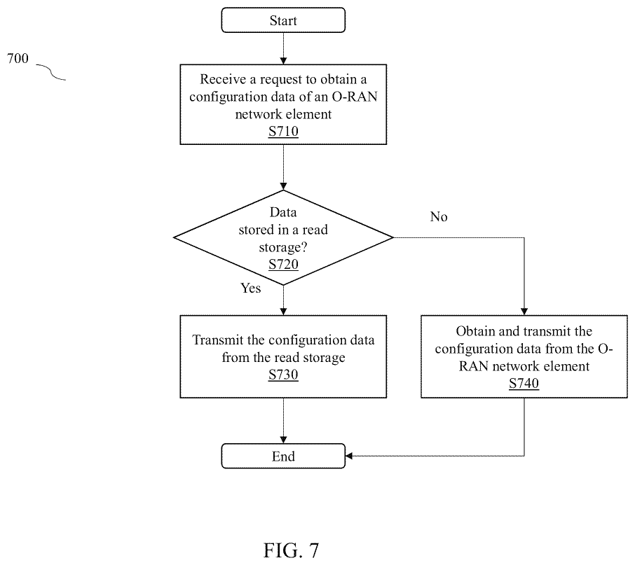

At operation S420, in response to receiving the request to obtain the configuration data of the O-RAN network element, the at least one processor may be configured to obtain the configuration data using a read storage. According to embodiments, the read storage may be included in the SMO. According to embodiments, the read storage may be configured to store data of the O-RAN network element to be obtained for the read operation. For example, the read storage may be configured to store CM configuration data of the O-RAN network element which can be obtained for the read operation. Examples of operations for obtaining the configuration data using the read storage are described below with reference to FIG. 7. The method then proceeds to operation S430.

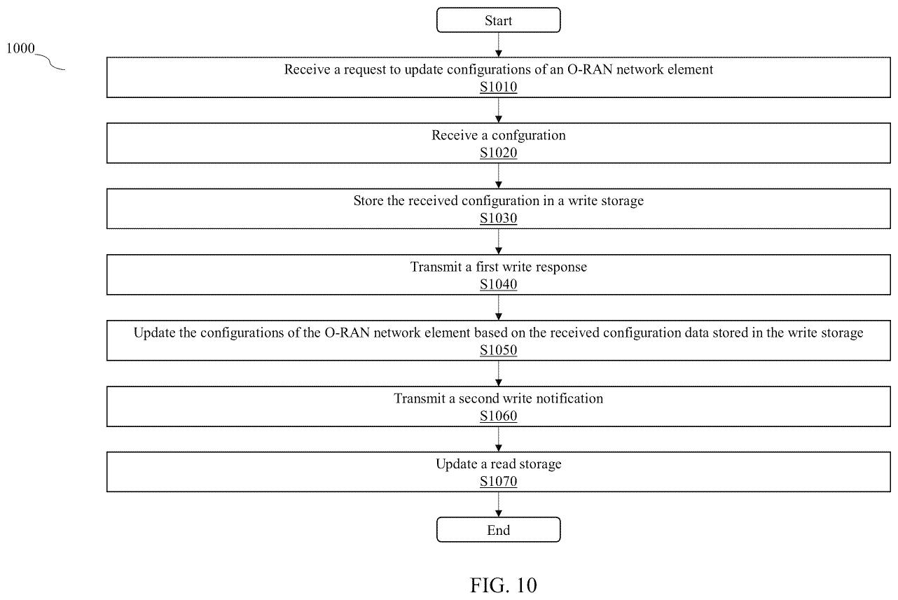

At operation S430, in response to receiving the request to update the configurations of the O-RAN network element, the at least one processor may be configured to update the configurations of the O-RAN network element based on the configuration provided in the request using a write storage. According to embodiments, the write storage may be included in the SMO. According to embodiments, the write storage may be different from the read storage. According to embodiments, the write storage may be configured to store data which the O-RAN network element is to be updated based on for the write operation. For example, the write storage may be configured to store CM configuration data to be written to the O-RAN network element. Examples of operations for updating the configurations of the O-RAN network element based on the configuration provided in the request using the write storage are described below with reference to FIG. 10.

Upon performing operation S420 and/or S430, the method 400 may be ended or be terminated. Alternatively, method 400 may return to operation S410, such that the at least one processor may be configured to repeatedly perform, for at least a predetermined amount of time, the receiving at least one of the requests (at operation S410), the obtaining the configuration data (at operation S420), and/or the updating the configurations of the O-RAN network element (at operation S430). For instance, the at least one processor may continuously (or periodically) receive the request to obtain the configuration data, and then restart the receiving at least one of the requests (at operation S410) and the obtaining the configuration data (at operation S420).

Further, for instance, the at least one processor may receive the request to obtain the configuration data (at operation S410), and obtain the configuration data (at operation S420). Then the at least one processor may receive the request to update the configurations of the O-RAN network element (at operation S410), and update the configurations of the O-RAN network element (at operation S430).

According to embodiments, in addition to receiving the request to obtain the configuration data of the O-RAN network element, the at least one processor may be configured to receive another request to obtain a configuration data of another O-RAN network element. For example, the at least one processor may be configured to receive a request to obtain a configuration data of a first O-RAN network element and receive a request to obtain a configuration data of a second O-RAN network element different from the first O-RAN network element. Similarly, according to embodiments, in addition to receiving the request to update the configurations of the O-RAN network element, the at least one processor may be configured to receive another request to update the configurations of another O-RAN network element. For example, the at least one processor may be configured to receive a request to update the configurations of a first O-RAN network element and receive a request to update the configurations of a second O-RAN network element different from the first O-RAN network element. The above requests may be received from the same or different rApp or other SMO functions.

According to embodiments, two or more of the above requests for different O-RAN network elements may be bundled into a single Application Programming Interface (API) call.

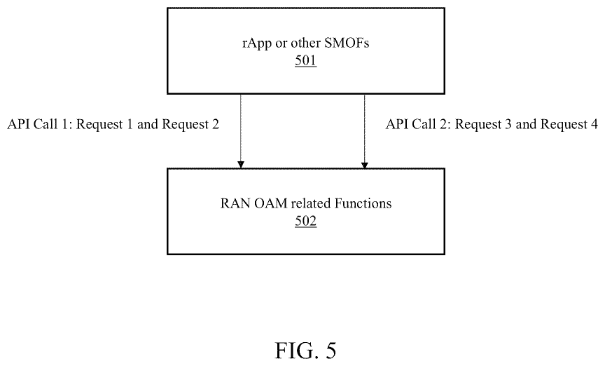

For example, as shown in FIG. 5 that illustrates a block diagram of an example interaction between an rApp or other SMO functions and the RAN OAM related Functions, according to one or more embodiments, the request to obtain the configuration data of the first O-RAN network element (Request 1) and the request to obtain the configuration data of the second O-RAN network element (Request 2) may be bundled into a single Application Programming Interface (API) call (API Call 1). Similarly, the request to update the configurations of the first O-RAN network element (Request 3) and the request to update the configurations of the second O-RAN network element (Request 4) may be bundled into a single Application Programming Interface (API) call (API Call 2).

The above configuration allows for the signaling load on the interface between the rApp or other SMO functions and the RAN OAM related Functions to be further reduced. For example, the signaling load on the R1 interface between an rApp and a Non-RT RIC may be further reduced.

According to embodiments, the read storage and the write storage may be configured to store all CM configuration data (Managed Object Instance (MOI) attributes) of all O-RAN network elements in the network. According to embodiments, the read storage and the write storage may be configured to store at least CM configuration data (MOI attributes) that are accessed most frequently by rApps in the network, in order to reduce the size and improve the efficiency. According to embodiments, the read and write storages can be replaced with digital twins (DTs) which is a full digital replica of the O-RAN network elements including not only the O-RAN network elements configurations but also all the other running states in the protocol stacks of the O-RAN network elements/functions. In this case, the read storage is replaced by DT1 replicating the current state of the O-RAN network elements, and the write storage is replaced by DT2 representing the future state of the O-RAN network elements in digital domain assuming the given configuration changes are applied.

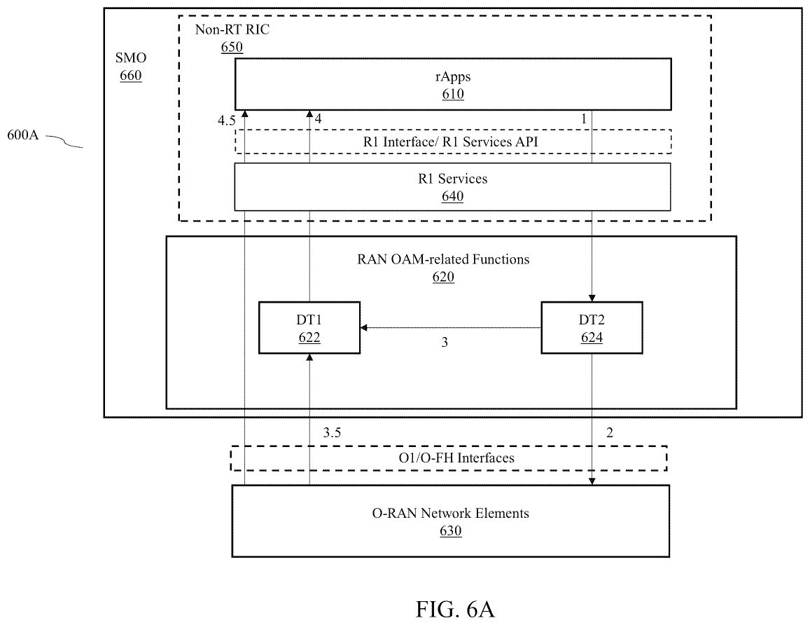

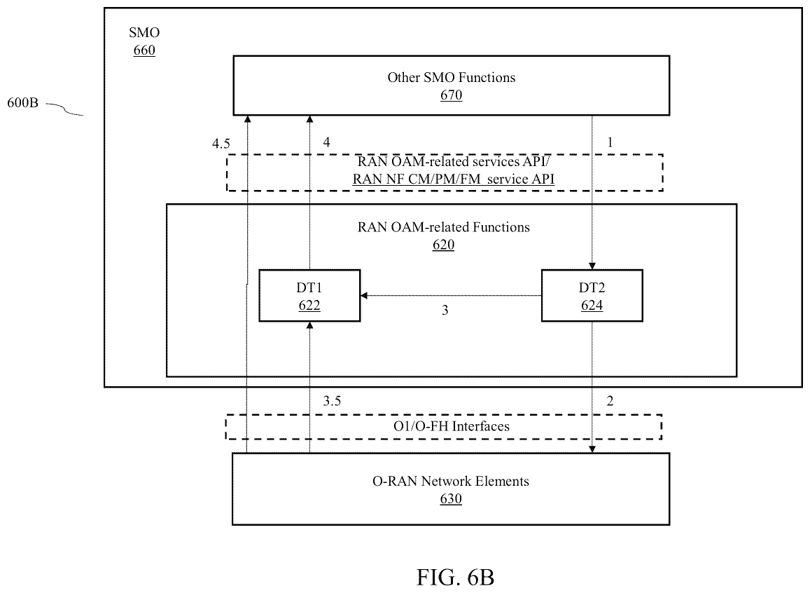

For example, referring to FIG. 6A that illustrates another example flow of data in a system 600A for managing data transfer in a network, according to one or more embodiments. As shown in FIG. 6A, the configuration and steps related to system 600A may be similar to the configuration and steps related to system 300A described above in relation to FIG. 3A. However, the read storage 322 is now replaced by DT1 622, which is a replica of the O-RAN network elements 630 for the read configuration data operation. Similarly, write storage 324 is now replaced by DT2 624, which represents the future state of the O-RAN network elements 630 (assuming the given configurations are applied) for the write configuration changes operation. The DT1 622 representing a replica of the current state of the O-RAN network elements 630 still gets updated to represent the true current configurations of the O-RAN network elements 630 based on the steps 3 and 3.5 described above in relation to FIG. 3A. The configurations in DT2 624 representing future state of the O-RAN network elements 630 still get populated to the O-RAN network elements 630 based on the step 2 described above in relation to FIG. 3A

FIG. 6B illustrates an example flow of data in a system 600B for managing data transfer in a network, according to one or more embodiments.

As illustrated in FIG. 6B, the configuration of system 600B may be similar to the configuration of system 600A in FIG. 6A, where operations related to the read data and write data are performed by other SMO functions 670 via RAN OAM-related services API/RAN NF CM/PM/FM service API instead of rApps 610 via R1 Interface/R1 Services API and R1 Services 640.

Accordingly, it may be understood that other SMO functions 670 may perform a write operation to update the O-RAN network elements 630 as well as perform a read operation to obtain data from the O-RAN network elements 630, in the similar manner as the rApps 610.

### Example Operations for Obtaining a Configuration Data using a Read Storage in the Present Disclosure

FIG. 7 illustrates a flow diagram of an example method 700 for obtaining the configuration data using the read storage, according to one or more embodiments. One or more operations of method 700 may be part of operation S410 and S420 in method 400, and may be performed by at least one processor.

As illustrated in FIG. 7, at operation S710, the at least one processor may be configured to receive a request to obtain a configuration data of an O-RAN network element. It may be understood that the request to obtain the configuration data of the O-RAN network element may be received from an rApp or other SMO functions, in the similar manner as described above in relation to method 400. According to embodiments, the read storage may have been synchronized with the network prior to operation S710, such that the read storage correctly reflects the current configuration of the O-RAN network element. The method then proceeds to operation S720.

At operation S720, the at least one processor may be configured to determine whether the configuration data is stored in the read storage. Accordingly, based on determining that the configuration data is stored in the read storage, the at least one processor may determine that it is not necessary to obtain the configuration data from the O-RAN network element, and the method proceeds to operation S730. On the other hand, based on determining that the configuration data is not stored in the read storage, the at least one processor may determine that it is necessary to obtain the configuration data from the O-RAN network element, and the method proceeds to operation S740.

At operation S730, the at least one processor may be configured to transmit the configuration data from the read storage to the rApp or other SMO functions. For example, the at least one processor may be configured to transmit a CM configuration data from the read storage to an rApp via the R1 interface, without having to obtain the CM configuration data from the O-RAN network element via the O1 or O-FH interface.

At operation S740, the at least one processor may be configured to obtain and transmit the configuration data from the O-RAN network element to the rApp or other SMO functions. For example, the at least one processor may be configured to obtain the CM configuration data from the O-RAN network element via the O1 or O-FH interface, and then transmit the CM configuration data to the rApp via the R1 interface.

Accordingly, the above process for obtaining the configuration data involving the read storage allows for the rApp or other SMO functions to obtain the configuration data, without having to communicate with the O-RAN network element, thereby avoiding unnecessary signaling load, bandwidth overhead, and delay associated with communicating with the O-RAN network element. Subsequently, the above process reduces processing and memory load on the SMO and RIC platform, which improves the scalability of the network.

### O-RAN Interfaces Message Flows for Reading Configuration Data

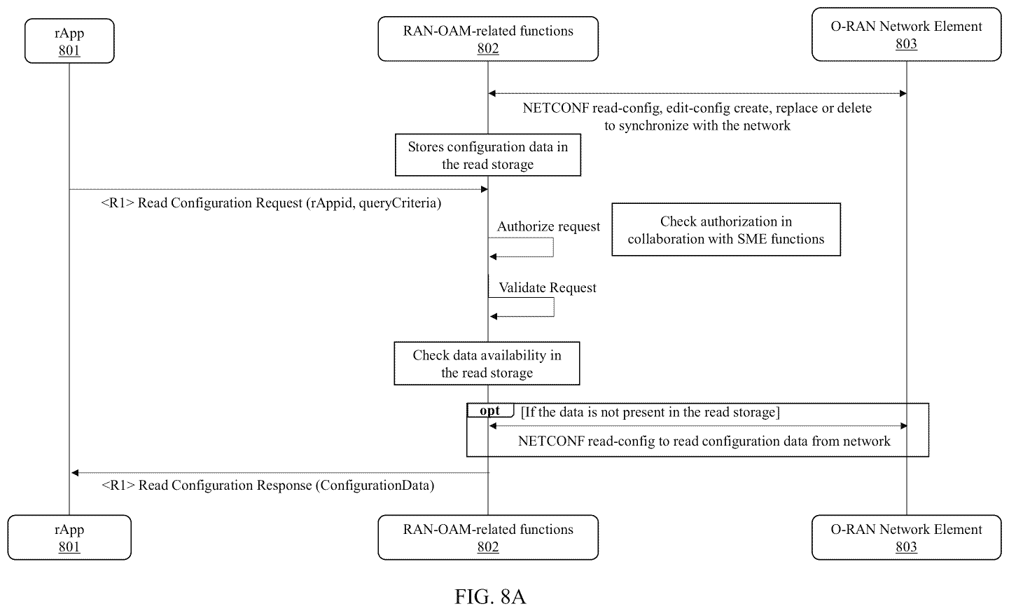

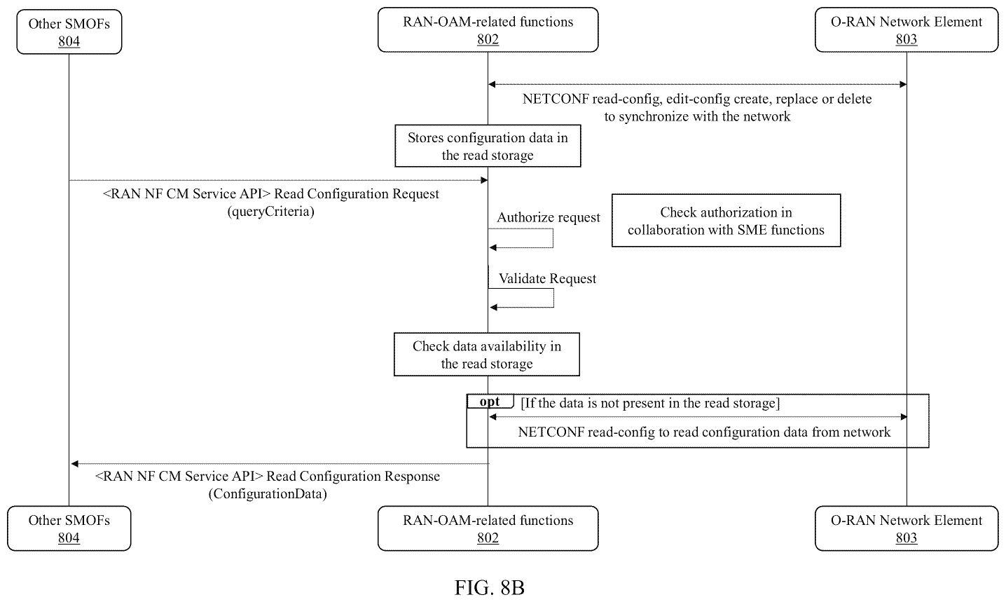

FIG. 8A discloses the call flows for an rApp to obtain the configuration data using the read storage in the RAN OAM-related functions, according to one or more embodiments.

As illustrated in FIG. 8A, the RAN-OAM related functions 802 may first synchronize the read storage with the O-RAN network elements in order to obtain the current MOI attributes (i.e., CM configuration data) of the network elements 803. In order to synchronize the read storage with the network, the RAN-OAM related functions 802 may communicate with the O-RAN network elements 803 via the O1 interface utilizing the network management protocol NETCONF read-config, edit-config create, and replace or delete. Once the current MOI attributes of the O-RAN network elements 803 are obtained, the RAN-OAM related functions 802 may store the retrieved configuration data in the read storage, such that the configuration data of the O-RAN network elements 803 stored in the read storage correctly reflect the current configurations of the O-RAN network elements 803.

The RAN-OAM related functions 802 may then receive a Read Configuration Request from the rApp 801, requesting to obtain (read) the configurations of the O-RAN network elements 803. The Read Configuration Request may include data, such as rAppid and queryCriteria related to the request, and will be received via the R1 interface.

In response, the RAN-OAM related functions 802 may perform authorization (AuthZ) and validation on the received request.

Once the received request is authenticated and validated, the RAN-OAM related functions 802 may determine whether requested the configuration data of the O-RAN network elements 803 are stored in the read storage.

If the requested configuration data of the O-RAN network elements 803 are stored (present) in the read storage, the RAN-OAM related functions 802 may transmit a Read Configuration Response to the rApp 801, providing the requested configuration data of the targeted O-RAN network elements 803. The Read Configuration Response may include data, such as ConfigurationData related to the request, and may be transmitted via the R1 interface.

If the requested configuration data of the targeted O-RAN network elements 803 are not stored in the read storage, the RAN-OAM related functions 802 may obtain the requested configuration of the O-RAN network elements 803 from the O-RAN network elements 803. In order to obtain the requested configuration data of the O-RAN network elements 803 from the O-RAN network elements 803, the RAN-OAM related functions 802 may communicate with the O-RAN network elements 803 via the O1 interface utilizing the network management protocol NETCONF read-config. Once the requested configuration data of the O-RAN network elements 803 are obtained from the O-RAN network elements 803, the RAN-OAM related functions 802 may transmit the Read Configuration Response to the rApp 801, in the same manner as described above.

FIG. 8B discloses the call flows for other SMO Functions (SMOFs) to obtain the configuration data using the read storage in the RAN OAM-related functions, according to one or more embodiments.

As illustrated in FIG. 8B, the call flows shown in FIG. 8B may be similar to the call flows shown in FIG. 8A, where operations related to obtaining the configuration data are performed by other SMOFs 804 via RAN NF CM Service API instead of rApps 801 via R1 Interface.

Accordingly, it may be understood that other SMOFs 804 may perform a read operation to obtain configuration data from the O-RAN network elements 803, in the similar manner as the rApps 801.

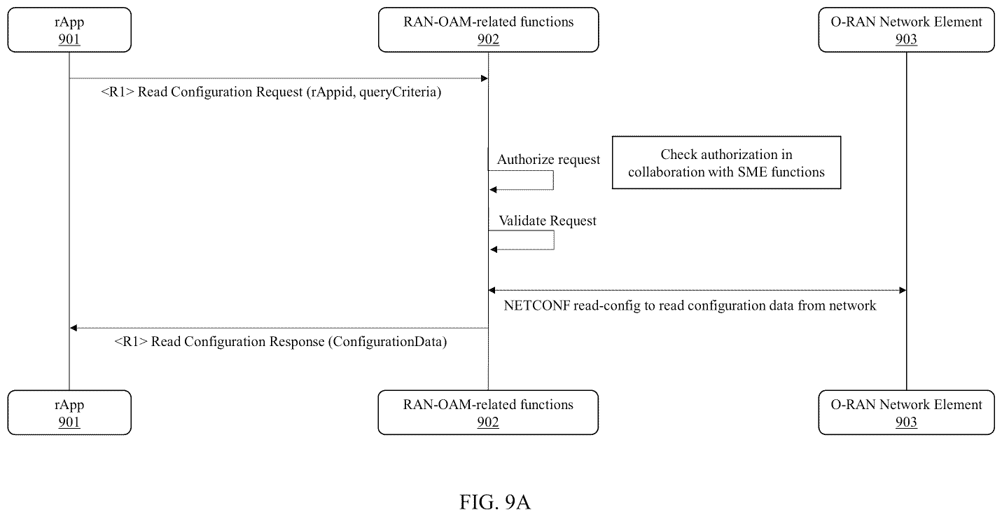

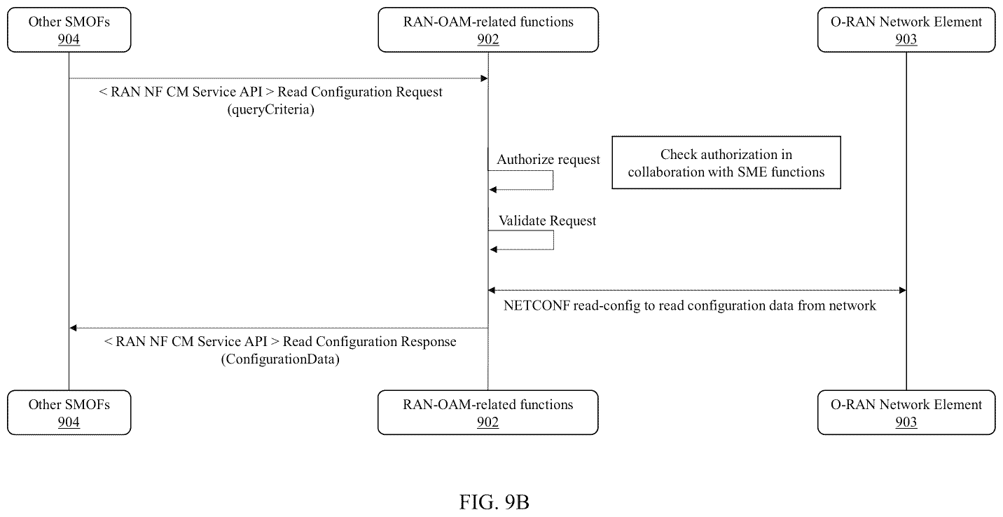

FIG. 9A discloses the call flow for an rApp to obtain the configuration data without using the read storage.

As illustrated in FIG. 9A, the disclosed call flow for obtaining the configuration data without using the read storage (the read storage may not exist at all in a particular implementation of the RAN OAM-related function) may be similar to the call flow for obtaining the configuration data using the read storage described above in relation to FIG. 8A.

However, as shown in FIG. 9A, in this case, once the RAN-OAM related functions 902 receive, authenticate, and validate the Read Configuration Request, the RAN-OAM related functions 902 directly obtain the requested configuration data of the targeted O-RAN network elements 903 from the O-RAN network elements 903 and transmit the Read Configuration Response to the rApp 901 with the retrieved configuration data from the O-RAN network elements.

It may be understood that, when an rApp 901 tries to obtain the requested configuration data of the O-RAN network elements 903 in the above process, the requested configuration data may need to be fetched from the O1 interface by the RAN OAM-related functions every time, which increases signaling load, bandwidth overhead, and delay as the network scales up and more rApps and O-RAN network elements operate in the network.

FIG. 9B discloses the call flows for other SMO Functions (SMOFs) to obtain the configuration data without using the read storage.

As illustrated in FIG. 9B, the call flows shown in FIG. 9B may be similar to the call flows shown in FIG. 9A, where operations related to obtaining the configuration data are performed by other SMOFs 904 via RAN NF CM Service API instead of rApps 901 via R1 Interface.

Accordingly, it may be understood that other SMOFs 904 may perform a read operation to obtain configuration data from the O-RAN network elements 903, in the similar manner as the rApps 901.

### Example Operations for Updating the Configurations of an O-RAN Network Element Using a Write Storage in the Present Disclosure

FIG. 10 illustrates a flow diagram of an example method 1000 for updating configurations of an O-RAN network element using a write storage, according to one or more embodiments. One or more operations of method 1000 may be part of operation S410 and S430 in method 400, and may be performed by at least one processor.

As illustrated in FIG. 10, at operation S1010, the at least one processor may be configured to receive a request to update configurations of an O-RAN network element. It may be understood that the request to update the configurations of the O-RAN network element may be received from an rApp or other SMO functions, in the similar manner as described above in relation to method 400. The method then proceeds to operation S1020.

At operation S1020, the at least one processor may be configured to receive a configuration. According to embodiments, the request received from the rApp or other SMO functions may include a configuration which the configurations of the O-RAN network element is to be updated based on. For example, the CM configuration data may be received from the rApp via the R1 interface. The method then proceeds to operation S1030.

At operation S1030, the at least one processor may be configured to store the received configuration in the write storage. The method then proceeds to operation S1040.

At operation S1040, the at least one processor may be configured to transmit a first write response to the rApp or other SMO functions. According to embodiments, the at least one processor may be configured to transmit the first write response to the rApp or other SMO functions after storing the received configuration in the write storage. According to embodiments, the first write response may be configured to notify the rApp or other SMO functions that the received configuration is stored in the write storage. The method then proceeds to operation S1050.

At operation S1050, the at least one processor may be configured to update the configurations of the O-RAN network element based on the received configuration stored in the write storage. For example, CM configuration data of the O-RAN network element may be updated based on the CM configuration data stored in the write storage (i.e., CM configuration data received from the rApp) via the O1 or O-FH interfaces, such that the CM configuration data stored in the write storage is written to the O-RAN network element via the O1 or O-FH interfaces.

As a further example, in order to update the configurations of the O-RAN network element based on the received configuration (write the received configuration to the O-RAN network element), the at least one processor may perform a ModifyMOI operation on the O1 or O-FH interfaces. Once the ModifyMOI operation is completed and the O-RAN network element is updated, the at least one processor may receive a ModifyMOI response from the O-RAN network element, indicating that the configuration changes have been successfully received and applied in the O-RAN network element. The method then proceeds to operation S1060.

At operation S1060, the at least one processor may be configured to transmit a second write notification to the rApp or other SMO functions. According to embodiments, the at least one processor may be configured to transmit the second write notification to the rApp or other SMO functions after the configurations of the O-RAN network element is updated based on the received configuration stored in the write storage. For example, the at least one processor may be configured to transmit the second write notification to the rApp after receiving the ModifyMOI response from the O-RAN network element.

According to embodiments, the second write notification may be configured to notify the rApp or other SMO functions that the configurations of the O-RAN network element is updated based on the received configuration stored in the write storage. The method then proceeds to operation S1070.

At operation S1070, the at least one processor may be configured to update the read storage. According to embodiments, the at least one processor may be configured to update the read storage based on the received configuration stored in the write storage. For example, the CM configuration data of the O-RAN network element stored in the read storage may be updated based on the CM configuration data stored in the write storage (which the configurations of the O-RAN network element has already been updated based on), such that the CM configuration data stored in the read storage is updated to correctly reflects the updated O-RAN network element, without having to communicate with the O-RAN network element via the O1 and O-FH interfaces.

According to embodiments, the at least one processor may be configured to update the read storage based on the received configuration stored in the write storage after the configurations of the O-RAN network element are updated based on the received configuration stored in the write storage. For example, the at least one processor may be configured to update the read storage based on the received configuration stored in the write storage after receiving the ModifyMOI response from the O-RAN network element.

According to embodiments, the at least one processor may be configured to further update the read storage based on the updated O-RAN network element. According to embodiments, the read storage may be updated based on the updated O-RAN network element periodically, in order to ensure that the data stored in the read storage correctly reflects data in the O-RAN network element. For example, the read storage may be updated based on the updated O-RAN network element via the O1 or O-FH interfaces periodically.

Accordingly, the above process for updating the O-RAN network element involving the write storage allows for the rApp or other SMO functions to simply transmit the configuration and to be free to perform other tasks while the configurations of the O-RAN network element is being updated based on the transmitted configuration, without having to wait for the completion of the update. Subsequently, the above process prevents a case where too many rApp or other SMO functions are being held at the same time as they are waiting for their respective update request to be completed, which may lead to platform overloading in signaling spike occasions.

Further, the above process for updating the read storage based on the configuration stored in the write storage allows for data stored in the read storage (which is to be used for the read operation) to correctly reflect data in the O-RAN network element, without having to directly communicate with the O-RAN network element, thereby avoiding unnecessary signaling load, bandwidth overhead, and delay associated with communicating directly with the O-RAN network element. Subsequently, the above process further reduces processing and memory load on the SMO and RIC platform, which improves the scalability of the network.

Furthermore, the above processes for obtaining the configuration data and updating the configurations of the O-RAN network element involving two separate storages allow for the data to be obtained from and transmitted to the O-RAN network element, without interfering with each other.

### O-RAN Interfaces Message Flows for Writing Configuration Data

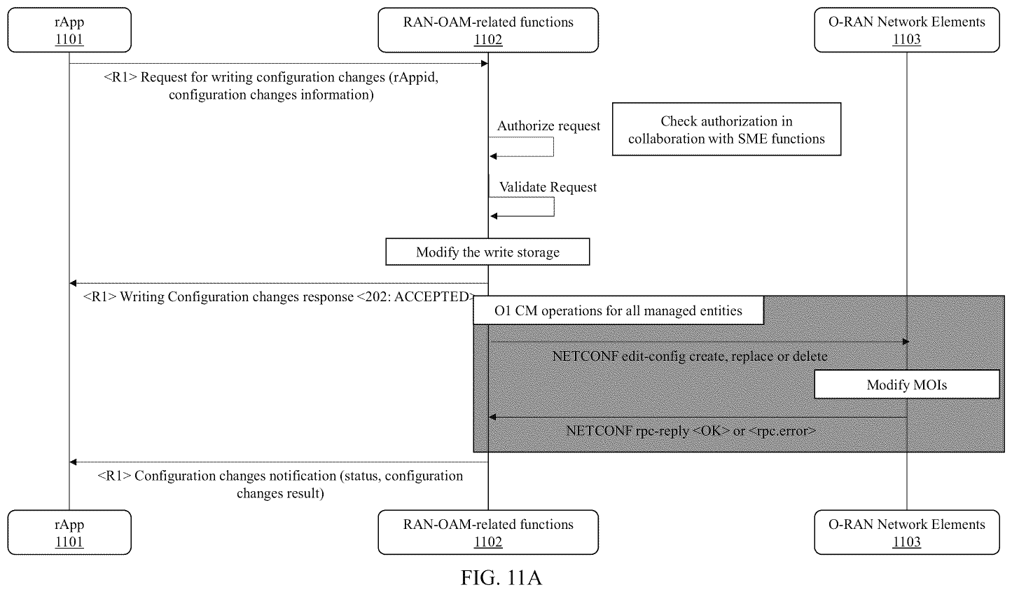

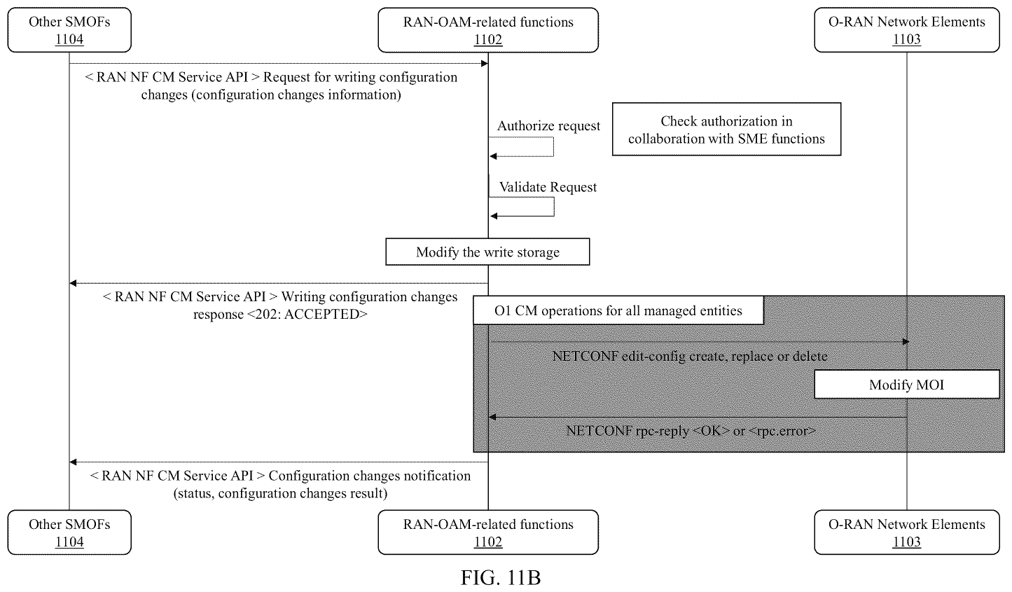

FIG. 11A discloses the call flow for an rApp to update the configurations of the O-RAN network elements using the write storage, according to one or more embodiments.

As illustrated in FIG. 11A, the RAN-OAM related functions 1102 may receive a Request for writing configuration changes from the rApp 1101, requesting to update (write) the configuration attributes of the targeted O-RAN network elements 1103. The request may include rAppid, and configuration changes information related to the request, and may be received via the R1 interface.

In response, the RAN-OAM related functions 1102 may perform authorization (AuthZ) and validation on the received request.

Once the received request is authenticated and validated, the RAN-OAM related functions 1102 may modify the write storage, such that the configuration attributes which the O-RAN network elements 1103 are to be updated are stored in the write storage.

Once the write storage is modified, the RAN-OAM related functions 1102 may transmit a Writing configuration changes response to the rApp 1101, indicating that the request is accepted and the configuration changes are stored in the write storage, but the actual process to update the O-RAN network elements 1103 is still pending. The Writing configuration changes response may include a return code 202: ACCEPTED in case of HTTP/REST API operation.

The RAN-OAM related functions 1102 may then update the O-RAN network elements 1103 based on the stored configuration attributes, by communicating with the O-RAN network elements 803 via the O1 interface utilizing the network management protocol NETCONF edit-config create, replace or delete, and rpc-reply <OK> or <rpc.error>. Accordingly, the configurations/MOI attributes of the network elements 1103 may be modified (updated) based on the configuration attributes stored in the write storage.

Once the O-RAN network elements 1103 is updated, the RAN-OAM related functions 1102 may transmit a Configuration changes notification to the rApp 1101, indicating that the O-RAN network elements 1103 are successfully updated and the provided configuration changes are effective in the network. The Configuration changes notification may include status indicating the operation over O1 interface is complete along with the result information indicating which configuration attributes are successfully configured in the O-RAN network elements 1103 which are not in case of the partial success scenario.

FIG. 11B discloses the call flows for other SMO Functions (SMOFs) to update the configurations of the O-RAN network elements using the write storage, according to one or more embodiments.

As illustrated in FIG. 11B, the call flows shown in FIG. 11B may be similar to the call flows shown in FIG. 11A, where operations related to updating the configurations of the O-RAN network elements are performed by other SMOFs 1104 via RAN NF CM Service API instead of rApps 1101 via R1 Interface.

Accordingly, it may be understood that other SMOFs 1104 may perform a write operation to update the configurations of the O-RAN network elements 1103, in the similar manner as the rApps 1101.

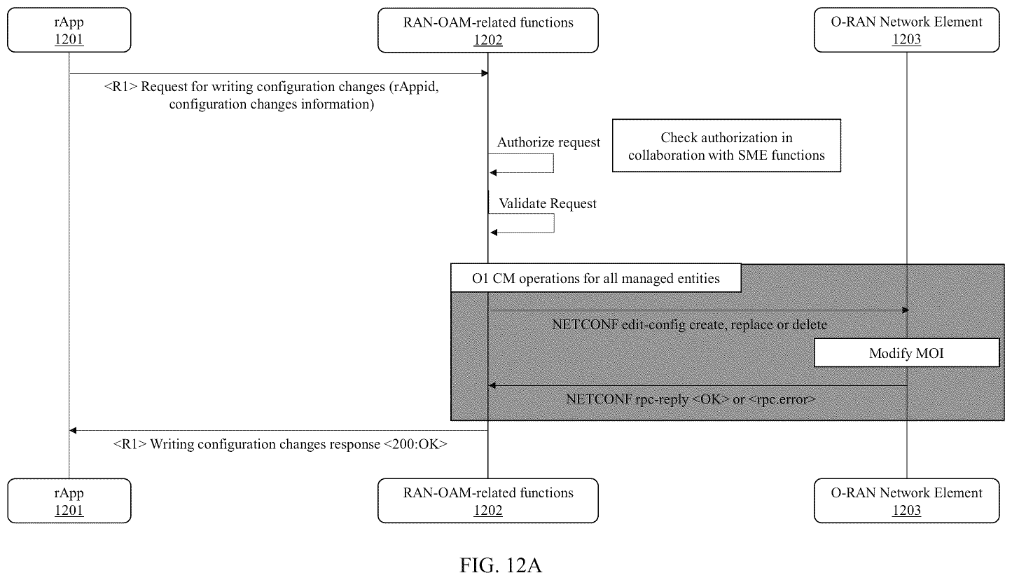

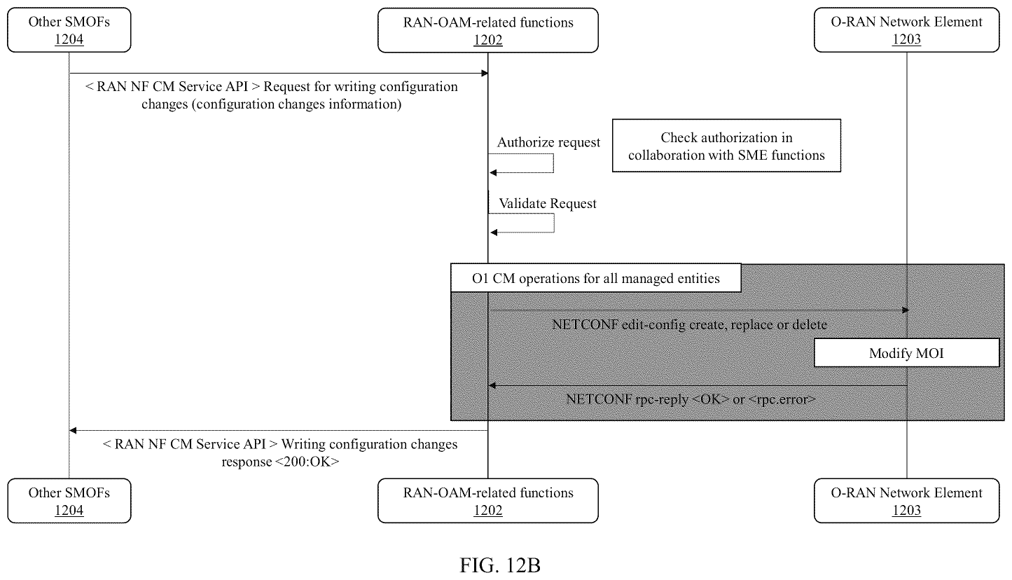

FIG. 12A discloses the call flow for an rApp to update the configurations of the O-RAN network elements without using the write storage.

As illustrated in FIG. 12A, the call flow for updating the configurations of the O-RAN network elements 1203 without using the write storage may be similar to the call flow for updating the configurations of the O-RAN network elements using the write storage described above in relation to FIG. 11A. However, as shown in FIG. 12A, in this case, once the RAN-OAM related functions 1202 receive, authenticate, and validate the Request for writing configuration changes, the RAN-OAM related functions 1202 may directly update the O-RAN network elements 1203 based on the received configuration attributes. Once the O-RAN network elements 1203 are updated, the RAN-OAM related functions 1202 may transmit a Writing Configuration changes response to the rApp 1201, indicating that the O-RAN network elements 1203 are successfully updated and the provided configuration attributes are effective in the network. The Writing configuration changes response may include a response code 200: OK in case of HTTP/REST API operation.

It may be understood that, in the above process, the RIC may block the rApp 1201 and hold the context for the write configuration request until all the O-RAN network elements 1203 are updated. Further, the rApp 1201 may not be able to recognize the process of the updating the O-RAN network elements 1203 until the update is completed and the Writing configuration changes response is received. Accordingly, as the network scales up and more rApps and O-RAN network elements operate in the network, the RIC may block and hold too many rApps and contexts at the same time while waiting for the update process to be completed over the O1 and O-FH interfaces, which may lead to platform overloading and signaling spike.

FIG. 12B discloses the call flows for other SMO Functions (SMOFs) to update the configurations of the O-RAN network elements without using the write storage.

As illustrated in FIG. 12B, the call flows shown in FIG. 12B may be similar to the call flows shown in FIG. 12A, where operations related to updating the configurations of the O-RAN network elements are performed by other SMOFs 1204 via RAN NF CM Service API instead of rApps 1201 via R1 Interface.

Accordingly, it may be understood that other SMOFs 1204 may perform a write operation to update the configurations of the O-RAN network elements 1203, in the similar manner as the rApps 1201.

### Example Implementation Environment

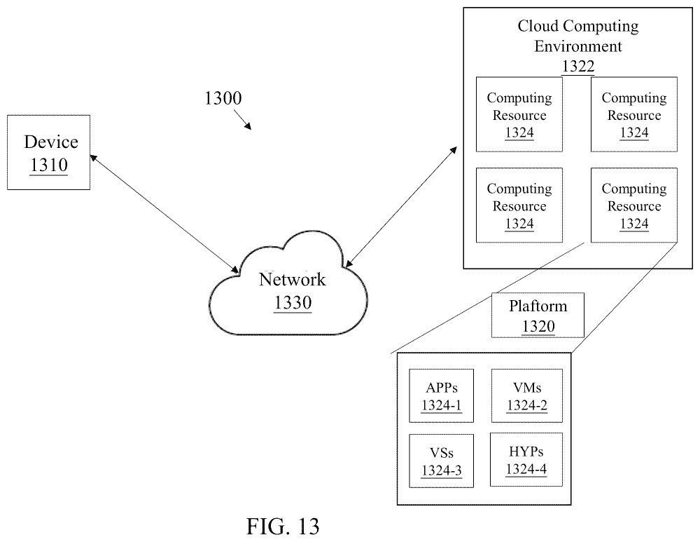

FIG. 13 illustrates a diagram of an example environment 1300 in which systems and/or methods, described herein, may be implemented. As shown in FIG. 13, environment 1300 may include a device 1310, a platform 1320, and a network 1330. Devices of environment 1300 may interconnect via wired connections, wireless connections, or a combination of wired and wireless connections. In some embodiments, any of the functions and operations described with reference to FIG. 3 to FIG. 12 above may be performed by any combination of elements illustrated in FIG. 13.

According to embodiments, system described herein may be stored, hosted, or deployed in the cloud computing platform 1320. In this regard, device 1310 may include a device, system, equipment, or the like, utilized by the user (e.g., user of a marketing team, user of a network planning team, etc.) to access the system. In that case, device 1310 may include one or more devices capable of receiving, generating, storing, processing, and/or providing information associated with platform 1320.

Platform 1320 includes one or more devices capable of receiving, generating, storing, processing, and/or providing information. In some implementations, platform 1320 may include a cloud server or a group of cloud servers. In some implementations, platform 1320 may be designed to be modular such that certain software components may be swapped in or out depending on a particular need. As such, platform 1320 may be easily and/or quickly reconfigured for different uses.

In some implementations, as shown, platform 1320 may be hosted in cloud computing environment 1322. Notably, while implementations described herein describe platform 1320 as being hosted in cloud computing environment 1322, in some implementations, platform 1320 may not be cloud-based (i.e., may be implemented outside of a cloud computing environment) or may be partially cloud-based.

Cloud computing environment 1322 includes an environment that hosts platform 1320. Cloud computing environment 1322 may provide computation, software, data access, storage, etc. services that do not require end-user (e.g., user device 1310) knowledge of a physical location and configuration of system(s) and/or device(s) that hosts platform 1320. As shown, cloud computing environment 1322 may include a group of computing resources 1324 (referred to collectively as “computing resources 1324” and individually as “computing resource 1324”).

Computing resource 1324 includes one or more personal computers, a cluster of computing devices, workstation computers, server devices, or other types of computation and/or communication devices. In some implementations, computing resource 1324 may host platform 1320. The cloud resources may include compute instances executing in computing resource 1324, storage devices provided in computing resource 1324, data transfer devices provided by computing resource 1324, etc. In some implementations, computing resource 1324 may communicate with other computing resources 1324 via wired connections, wireless connections, or a combination of wired and wireless connections.

As further shown in FIG. 13, computing resource 1324 includes a group of cloud resources, such as one or more applications (“APPs”) 1324-1, one or more virtual machines (“VMs”) 1324-2, virtualized storage (“VSs”) 1324-3, one or more hypervisors (“HYPs”) 1324-4, or the like. While the current example embodiment is with reference to virtualized network functions, it is understood that one or more other embodiments are not limited thereto, and may be implemented in at least one of containers, cloud-native services, one or more container platforms, etc. For example, in one or more other example embodiments, any of the above-described components may be a software-based component deployed or hosted in, for example, a server cluster such as a hybrid cloud server, data center servers, and the like. The software-based component may be containerized and may be deployed and controlled by one or more machines, called “nodes”, that run or execute the containerized O-RAN network elements and are addressable. In this regard, a server cluster may contain at least one master node and a plurality of worker nodes, wherein the master node(s) controls and manages a set of associated worker nodes.

Application 1324-1 includes one or more software applications that may be provided to or accessed by user device 1310. Application 1324-1 may eliminate a need to install and execute the software applications on user device 1310. For example, application 1324-1 may include software associated with platform 1320 and/or any other software capable of being provided via cloud computing environment 1322. In some implementations, one application 1324-1 may send/receive information to/from one or more other applications 1324-1, via virtual machine 1324-2.

Virtual machine 1324-2 includes a software implementation of a machine (e.g., a computer) that executes programs like a physical machine. Virtual machine 1324-2 may be either a system virtual machine or a process virtual machine, depending upon use and degree of correspondence to any real machine by virtual machine 1324-2. A system virtual machine may provide a complete system platform that supports execution of a complete operating system (“OS”). A process virtual machine may execute a single program, and may support a single process. In some implementations, virtual machine 1324-2 may execute on behalf of a user (e.g., user device 1310), and may manage infrastructure of cloud computing environment 1322, such as data management, synchronization, or long-duration data transfers.

Virtualized storage 1324-3 includes one or more storage systems and/or one or more devices that use virtualization techniques within the storage systems or devices of computing resource 1324. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 1324-4 may provide hardware virtualization techniques that allow multiple operating systems (e.g., “guest operating systems”) to execute concurrently on a host computer, such as computing resource 1324. Hypervisor 1324-4 may present a virtual operating platform to the guest operating systems, and may manage the execution of the guest operating systems. Multiple instances of a variety of operating systems may share virtualized hardware resources.

Network 1330 may include one or more wired and/or wireless networks. For example, network 1330 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 13 are provided as an example. In practice, there may be additional devices and/or networks, fewer devices and/or networks, different devices and/or networks, or differently arranged devices and/or networks than those shown in FIG. 13. Furthermore, two or more devices shown in FIG. 13 may be implemented within a single device, or a single device shown in FIG. 13 may be implemented as multiple, distributed devices. Additionally, or alternatively, a set of devices (e.g., one or more devices) of environment 1300 may perform one or more functions described as being performed by another set of devices of environment 1300.

### Various Aspects of Embodiments

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s) module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Various further respective aspects and features of embodiments of the present disclosure may be defined by the following items:

Item [1]: An apparatus that may be configured to: receive, from an rApp or other SMO functions, at least one of a request to obtain a configuration data of an O-RAN network element, and a request to update configurations of an O-RAN network element; in response to receiving the request to obtain the configuration data of the O-RAN network element, obtain the configuration data using a read storage; and in response to receiving the request to update the configurations of the O-RAN network element, update the configurations of the O-RAN network element based on a configuration provided in the request using a write storage different from the read storage; wherein the write storage and the read storage may be included in the apparatus.

Item [2]: The apparatus according to item [1], wherein the apparatus may be configured to obtain the configuration data using the read storage by: determining whether the configuration data is stored in the read storage; and in response to determining that the configuration data is stored in the read storage, transmitting the configuration data from the read storage to the rApp or other SMO functions.

Item [3]: The apparatus according to one of items [1]-[2], wherein the apparatus may be configured to update the configurations of the O-RAN network element based on the configuration provided in the request using the write storage by: receiving the configuration from the rApp or other SMO functions; storing the received configuration in the write storage; and updating the configurations of the O-RAN network element based on the received configuration stored in the write storage.

Item [4]: The apparatus according to item [3], wherein the apparatus may be further configured to update the configurations the O-RAN network element based on the configuration provided in the request using the write storage by, after updating the configurations of the O-RAN network element based on the received configuration stored in the write storage, updating the read storage based on the received configuration stored in the write storage.

Item [5]: The apparatus according to one of items [3]-[4], wherein the apparatus may be further configured to update the configurations of the O-RAN network element based on the configuration provided in the request using the write storage by: after storing the received configuration in the write storage, transmitting a first response to the rApp or other SMO functions, wherein the first response may be configured to notify the rApp or other SMO functions that the received configuration is stored in the write storage; and after updating the configurations of the O-RAN network element based on the received configuration stored in the write storage, transmitting a second notification to the rApp or other SMO functions, wherein the second notification may be configured to notify the rApp or other SMO functions that the configurations of the O-RAN network element are updated based on the received configuration stored in the write storage.

Item [6]: The apparatus according to one of items [1]-[5], wherein: the O-RAN network element may be a first O-RAN network element; the apparatus may be further configured to receive, from an rApp or other SMO functions, a request to obtain a configuration data of a second O-RAN network element different from the first O-RAN network element; and the request to obtain the configuration data of the first O-RAN network element and the request to obtain the configuration data of the second O-RAN network element may be bundled into a single Application Programming Interface (API) call.

Item [7]: The apparatus according to one of items [1]-[6], wherein: the O-RAN network element may be a first O-RAN network element; the apparatus may be further configured to receive, from an rApp or other SMO functions, a request to update configurations of a second O-RAN network element different from the first O-RAN network element based on a configuration provided in the request to update the configurations of the second O-RAN network element; and the request to update the configurations of the first O-RAN network element and the request to update the configurations of the second O-RAN network element may be bundled into a single Application Programming Interface (API) call.

Item [8]: An apparatus that may be configured to: receive, from an rApp or other SMO functions, at least one of a request to obtain a configuration data of an O-RAN network element, and a request to update configurations of an O-RAN network element; in response to receiving the request to obtain the configuration data of the O-RAN network element, obtain the configuration data using a first digital twin; and in response to receiving the request to update the configurations of the O-RAN network element, update the configurations of the O-RAN network element based on a configuration provided in the request using a second digital twin different from the first digital twin; wherein the first digital twin and the second digital twin may be included in the apparatus, and wherein the first digital twin and the second digital twin may include a full digital replica of the O-RAN network element.

Item [9]: A method that may include: receiving, from an rApp or other SMO functions, at least one of a request to obtain a configuration data of an O-RAN network element, and a request to update configurations of an O-RAN network element; in response to receiving the request to obtain the configuration data of the O-RAN network element, obtaining the configuration data using a read storage; and in response to receiving the request to update the configurations of the O-RAN network element, updating the configurations of the O-RAN network element based on a configuration provided in the request using a write storage different from the read storage; wherein the write storage and the read storage may be included in an apparatus that performs the method.

Item [10]: The method according to item [9], wherein the obtaining the configuration data using the read storage may include: determining whether the configuration data is stored in the read storage; and in response to determining that the configuration data is stored in the read storage, transmitting the configuration data from the read storage to the rApp or other SMO functions.

Item [11]: The method according to one of items [9]-[10], wherein the updating the configurations the O-RAN network element based on the configuration provided in the request using the write storage may include: receiving the configuration from the rApp or other SMO functions; storing the received configuration in the write storage; and updating the configurations of the O-RAN network element based on the received configuration stored in the write storage.

Item [12]: The method according to item [11], wherein the updating the configurations of the O-RAN network element based on the configuration provided in the request using the write storage may further include, after updating the configurations of the O-RAN network element based on the received configuration stored in the write storage, updating the read storage based on the received configuration stored in the write storage.

Item [13]: The method according to one of items [11]-[12], wherein the updating the configurations of the O-RAN network element based on the configuration provided in the request using the write storage may further include: after storing the received configuration in the write storage, transmitting a first response to the rApp or other SMO functions, wherein the first response may be configured to notify the rApp or other SMO functions that the received configuration is stored in the write storage; and after updating the configurations of the O-RAN network element based on the received configuration stored in the write storage, transmitting a second notification to the rApp or other SMO functions, wherein the second notification may be configured to notify the rApp or other SMO functions that the configurations of the O-RAN network element are updated based on the received configuration stored in the write storage.

Item [14]: The method according to one of items [9]-[13], wherein: the O-RAN network element may be a first O-RAN network element; the method may further include receiving, from an rApp or other SMO functions, a request to obtain a configuration data of a second O-RAN network element different from the first O-RAN network element; and the request to obtain the configuration data of the first O-RAN network element and the request to obtain the configuration data of the second O-RAN network element may be bundled into a single Application Programming Interface (API) call.

Item [15]: The method according to one of items [9]-[14], wherein: the O-RAN network element may be a first O-RAN network element; the method may further include receiving, from an rApp or other SMO functions, a request to update configurations of a second O-RAN network element different from the first O-RAN network element based on a configuration provided in the request to update the configurations of the second O-RAN network element; and the request to update the configurations of the first O-RAN network element and the request to update the configurations of the second O-RAN network element may be bundled into a single Application Programming Interface (API) call.

Item [16]: A method that may include: receiving, from an rApp or other SMO functions, at least one of a request to obtain a configuration data of an O-RAN network element, and a request to update configurations of an O-RAN network element; in response to receiving the request to obtain the configuration data of the O-RAN network element, obtaining the configuration data using a first digital twin; and in response to receiving the request to update the configurations of the O-RAN network element, updating the configurations of the O-RAN network element based on a configuration provided in the request using a second digital twin different from the first digital twin; wherein the first digital twin and the second digital twin may be included in an apparatus that performs the method, and wherein the first digital twin and the second digital twin may include a full digital replica of the O-RAN network element.

Item [17]: A non-transitory computer-readable recording medium that may have recorded thereon instructions executable by an apparatus to cause the apparatus to perform a method including: receiving, from an rApp or other SMO functions, at least one of a request to obtain a configuration data of an O-RAN network element, and a request to update configurations of an O-RAN network element; in response to receiving the request to obtain the configuration data of the O-RAN network element, obtaining the configuration data using a read storage; and in response to receiving the request to update the configurations of the O-RAN network element, updating the configurations of the O-RAN network element based on a configuration provided in the request using a write storage different from the read storage; wherein the write storage and the read storage may be included in the apparatus.

Item [18]: The non-transitory computer-readable recording medium according to item [17], wherein the obtaining the configuration data using the read storage may include: determining whether the configuration data is stored in the read storage; and in response to determining that the configuration data is stored in the read storage, transmitting the configuration data from the read storage to the rApp or other SMO functions.

Item [19]: The non-transitory computer-readable recording medium according to one of items [17]-[18], wherein the updating the configurations the O-RAN network element based on the configuration provided in the request using the write storage may include: receiving the configuration from the rApp or other SMO functions; storing the received configuration in the write storage; and updating the configurations of the O-RAN network element based on the received configuration stored in the write storage.

Item [20]: The non-transitory computer-readable recording medium according to item [19], wherein the updating the configurations of the O-RAN network element based on the configuration provided in the request using the write storage may further include, after updating the configurations of the O-RAN network element based on the received configuration stored in the write storage, updating the read storage based on the received configuration stored in the write storage.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. An apparatus configured to:
receive, from an rApp or other SMO functions, at least one of a request to obtain a configuration data of an O-RAN network element, and a request to update configurations of an O-RAN network element;
in response to receiving the request to obtain the configuration data of the O-RAN network element, obtain the configuration data using a read storage; and
in response to receiving the request to update the configurations of the O-RAN network element, update the configurations of the O-RAN network element based on a configuration provided in the request using a write storage different from the read storage;
wherein the write storage and the read storage are comprised in the apparatus.

2. The apparatus according to claim 1, wherein the apparatus is configured to obtain the configuration data using the read storage by:
determining whether the configuration data is stored in the read storage; and
in response to determining that the configuration data is stored in the read storage, transmitting the configuration data from the read storage to the rApp or other SMO functions.

3. The apparatus according to claim 1, wherein the apparatus is configured to update the configurations of the O-RAN network element based on the configuration provided in the request using the write storage by:
receiving the configuration from the rApp or other SMO functions;
storing the received configuration in the write storage; and
updating the configurations of the O-RAN network element based on the received configuration stored in the write storage.

4. The apparatus according to claim 3, wherein the apparatus is further configured to update the configurations the O-RAN network element based on the configuration provided in the request using the write storage by, after updating the configurations of the O-RAN network element based on the received configuration stored in the write storage, updating the read storage based on the received configuration stored in the write storage.

5. The apparatus according to claim 3, wherein the apparatus is further configured to update the configurations of the O-RAN network element based on the configuration provided in the request using the write storage by:
after storing the received configuration in the write storage, transmitting a first response to the rApp or other SMO functions, wherein the first response is configured to notify the rApp or other SMO functions that the received configuration is stored in the write storage; and
after updating the configurations of the O-RAN network element based on the received configuration stored in the write storage, transmitting a second notification to the rApp or other SMO functions, wherein the second notification is configured to notify the rApp or other SMO functions that the configurations of the O-RAN network element are updated based on the received configuration stored in the write storage.

6. The apparatus according to claim 1, wherein:
the O-RAN network element is a first O-RAN network element;
the apparatus is further configured to receive, from an rApp or other SMO functions, a request to obtain a configuration data of a second O-RAN network element different from the first O-RAN network element; and
the request to obtain the configuration data of the first O-RAN network element and the request to obtain the configuration data of the second O-RAN network element are bundled into a single Application Programming Interface (API) call.

7. The apparatus according to claim 1, wherein:
the O-RAN network element is a first O-RAN network element;
the apparatus is further configured to receive, from an rApp or other SMO functions, a request to update configurations of a second O-RAN network element different from the first O-RAN network element based on a configuration provided in the request to update the configurations of the second O-RAN network element; and
the request to update the configurations of the first O-RAN network element and the request to update the configurations of the second O-RAN network element are bundled into a single Application Programming Interface (API) call.

8. An apparatus configured to:
receive, from an rApp or other SMO functions, at least one of a request to obtain a configuration data of an O-RAN network element, and a request to update configurations of an O-RAN network element;
in response to receiving the request to obtain the configuration data of the O-RAN network element, obtain the configuration data using a first digital twin; and
in response to receiving the request to update the configurations of the O-RAN network element, update the configurations of the O-RAN network element based on a configuration provided in the request using a second digital twin different from the first digital twin,
wherein the first digital twin and the second digital twin are comprised in the apparatus, and wherein the first digital twin and the second digital twin comprise a full digital replica of the O-RAN network element.

9. A method comprising:
receiving, from an rApp or other SMO functions, at least one of a request to obtain a configuration data of an O-RAN network element, and a request to update configurations of an O-RAN network element;
in response to receiving the request to obtain the configuration data of the O-RAN network element, obtaining the configuration data using a read storage; and
in response to receiving the request to update the configurations of the O-RAN network element, updating the configurations of the O-RAN network element based on a configuration provided in the request using a write storage different from the read storage;
wherein the write storage and the read storage are comprised in an apparatus that performs the method.

10. The method according to claim 9, wherein the obtaining the configuration data using the read storage comprises:
determining whether the configuration data is stored in the read storage; and
in response to determining that the configuration data is stored in the read storage, transmitting the configuration data from the read storage to the rApp or other SMO functions.

11. The method according to claim 9, wherein the updating the configurations the O-RAN network element based on the configuration provided in the request using the write storage comprises:
receiving the configuration from the rApp or other SMO functions;
storing the received configuration in the write storage; and
updating the configurations of the O-RAN network element based on the received configuration stored in the write storage.

12. The method according to claim 11, wherein the updating the configurations of the O-RAN network element based on the configuration provided in the request using the write storage further comprises, after updating the configurations of the O-RAN network element based on the received configuration stored in the write storage, updating the read storage based on the received configuration stored in the write storage.

13. The method according to claim 11, wherein the updating the configurations of the O-RAN network element based on the configuration provided in the request using the write storage further comprises:
after storing the received configuration in the write storage, transmitting a first response to the rApp or other SMO functions, wherein the first response is configured to notify the rApp or other SMO functions that the received configuration is stored in the write storage; and
after updating the configurations of the O-RAN network element based on the received configuration stored in the write storage, transmitting a second notification to the rApp or other SMO functions, wherein the second notification is configured to notify the rApp or other SMO functions that the configurations of the O-RAN network element are updated based on the received configuration stored in the write storage.

14. The method according to claim 9, wherein:
the O-RAN network element is a first O-RAN network element;
the method further comprises receiving, from an rApp or other SMO functions, a request to obtain a configuration data of a second O-RAN network element different from the first O-RAN network element; and
the request to obtain the configuration data of the first O-RAN network element and the request to obtain the configuration data of the second O-RAN network element are bundled into a single Application Programming Interface (API) call.

15. The method according to claim 9, wherein:
the O-RAN network element is a first O-RAN network element;
the method further comprises receiving, from an rApp or other SMO functions, a request to update configurations of a second O-RAN network element different from the first O-RAN network element based on a configuration provided in the request to update the configurations of the second O-RAN network element; and
the request to update the configurations of the first O-RAN network element and the request to update the configurations of the second O-RAN network element are bundled into a single Application Programming Interface (API) call.

16. A method comprising:
receiving, from an rApp or other SMO functions, at least one of a request to obtain a configuration data of an O-RAN network element, and a request to update configurations of an O-RAN network element;
in response to receiving the request to obtain the configuration data of the O-RAN network element, obtaining the configuration data using a first digital twin; and
in response to receiving the request to update the configurations of the O-RAN network element, updating the configurations of the O-RAN network element based on a configuration provided in the request using a second digital twin different from the first digital twin;
wherein the first digital twin and the second digital twin are comprised in an apparatus that performs the method, and wherein the first digital twin and the second digital twin comprise a full digital replica of the O-RAN network element.

17. A non-transitory computer-readable recording medium having recorded thereon instructions executable by an apparatus to cause the apparatus to perform a method comprising:
receiving, from an rApp or other SMO functions, at least one of a request to obtain a configuration data of an O-RAN network element, and a request to update configurations of an O-RAN network element;
in response to receiving the request to obtain the configuration data of the O-RAN network element, obtaining the configuration data using a read storage; and
in response to receiving the request to update the configurations of the O-RAN network element, updating the configurations of the O-RAN network element based on a configuration provided in the request using a write storage different from the read storage;
wherein the write storage and the read storage are comprised in the apparatus.

18. The non-transitory computer-readable recording medium according to claim 17, wherein the obtaining the configuration data using the read storage comprises:
determining whether the configuration data is stored in the read storage; and
in response to determining that the configuration data is stored in the read storage, transmitting the configuration data from the read storage to the rApp or other SMO functions.

19. The non-transitory computer-readable recording medium according to claim 17, wherein the updating the configurations the O-RAN network element based on the configuration provided in the request using the write storage comprises:
receiving the configuration from the rApp or other SMO functions;
storing the received configuration in the write storage; and
updating the configurations of the O-RAN network element based on the received configuration stored in the write storage.

20. The non-transitory computer-readable recording medium according to claim 19, wherein the updating the configurations of the O-RAN network element based on the configuration provided in the request using the write storage further comprises, after updating the configurations of the O-RAN network element based on the received configuration stored in the write storage, updating the read storage based on the received configuration stored in the write storage.
